(19) United States
(12) Patent Application Publication
(10) Pub. No.: US 2014/0113806 A1
(43) Pub. Date: Apr. 24, 2014

(54) BASIC CATALYST SUPPORT BODY HAVING A LOW SURFACE AREA

(71) Applicants: Alfred Hagemeyer, Sunnyvale, CA (US); Gerhard Mestl, Munchen (DE); Peter Scheck, Gilching (DE); Peter Bauer, Buch am Erlbach (DE); Andreas Pritzl, Bad Aibling (DE)

(72) Inventors: Alfred Hagemeyer, Sunnyvale, CA (US); Gerhard Mestl, Munchen (DE); Peter Scheck, Gilching (DE); Peter Bauer, Buch am Erlbach (DE); Andreas Pritzl, Bad Aibling (DE)

(73) Assignee: Clariant Produkte (Deutschland) Gmbh, Frankfurt/ Main (DE)

(21) Appl. No.: 14/113,684

(22) PCT Filed: Apr. 25, 2012
(86) PCT No.: PCT/EP12/57523

§ 371 Date: Dec. 19, 2013

(30) Foreign Application Priority Data
Apr. 26, 2011 (DE) 10 2011 018 532.1

(51) Int. Cl. B01J 23/66

(52) U.S. Cl. CPC B01J 23/66
USPC 502/242; 502/240; 502/243

(57) ABSTRACT

A catalyst support body containing an SiO₂-containing material and a metal selected from the group consisting of alkali metals, alkaline earth metals, rare earth metals and mixtures thereof, wherein the total metal content lies in the range of from 0.5 to 10 wt.-%, relative to the total weight of the catalyst support. Also, a catalyst that comprises a catalyst support body according to the invention and a catalytically active metal, in particular palladium and/or gold. Also, a method for producing a catalyst support, wherein an SiO₂-containing material is treated with a metal-containing compound, dried and then calcined. Also, a method for producing a catalyst, in which a solution having a precursor compound of a catalytically active metal is applied to a catalyst support body.

### CROSS-REFERENCE TO RELATED APPLICATIONS

This application is a U.S. National Stage application, claiming benefit under 35 U.S.C. §§120 and 365 of International Application No. PCT/EP2012/057523, filed Apr. 25, 2012, and claiming benefit under 35 U.S.C. §119 of German Application No. 10 2011 018 532.1, filed Apr. 26, 2011, the entire disclosures of both prior applications being incorporated herein by reference in their entirety.

### BACKGROUND

The present invention relates to a catalyst support body containing an SiO₂-containing material and a metal selected from the group consisting of alkali metals, alkaline earth metals, rare earth metals and mixtures thereof, wherein the total metal content lies in the range of from 0.5 to 10 wt.-%, relative to the total weight of the catalyst support. In addition, the present invention relates to a catalyst that comprises a catalyst support body according to the invention and a catalytically active metal, in particular palladium and/or gold. The present invention also relates to a method for producing a catalyst support according to the invention, wherein an SiO₂-containing material is treated with a metal-containing compound, dried and then calcined. A further embodiment of the present invention is a method for producing a catalyst according to the invention, in which a solution having a precursor compound of a catalytically active metal is applied to a catalyst support body according to the invention.

Catalysts are exposed to very high strains during their use and have to meet ever increasing requirements. Particularly high demands are made in particular on catalysts or their precursors which are present in the form of support bodies treated with a catalytically active substance and are introduced into systems in this way, which support bodies can no longer be altered, or can only be altered at great cost, after the systems have been filled. This applies for example to catalysts which are used to fill reactors, in particular multi-tube reactors.

It is known that a reduction in the activity or selectivity of a catalyst bed in a system can occur for example due to poisoning or coking of the catalyst. However, a reduction in the activity or selectivity of a catalyst bed can also occur due to damage to the catalysts, which can arise during the filling process or when heated to high temperatures. If cracks occur in the catalyst or a catalyst coating is split off from a catalyst, the catalyst no longer has the sought surface condition, which is important to fulfil the desired functions of the catalyst. It is therefore desirable to provide catalyst support shaped bodies which have a high mechanical stability.

In the chemical industry and research there is therefore a continued need for catalysts with a high mechanical load capacity. A known approach for increasing the mechanical load capacity is based for example on the improvement of the adhesion of the catalyst coating to the shaped body or an increase in the wear resistance of the catalyst coating. However, such an improvement in the properties of the catalyst coating is usually associated with a high outlay on work or materials and can involve a deterioration of the catalytic properties of the catalyst coating. Firstly, there are catalysts in which an additional coating in which the catalytically active substances are located is carried out on a catalyst support. Secondly, there are also catalysts in which the catalytically active materials are not present in an additional coating on the catalyst support body, but are present directly in the form of a shell in a particular area of the surface of the catalyst support body material itself. These two forms are manifestations of so-called shell catalysts.

In particular in the second-named variant of shell catalysts, it is necessary for the catalyst support body itself to have a high mechanical surface stability.

Furthermore, it is also desirable with respect to the catalytic activity of many catalysts for them to have a high pore volume. However, a high pore volume often leads to a lower mechanical stability.

It was thus desirable to provide a catalyst support body which, with respect to activity and selectivity, has a high pore volume with, at the same time, high mechanical stability.

### SUMMARY

This object was achieved by the provision of a catalyst support body which comprises both an SiO₂-containing material and a metal, wherein the total metal content lies in the range of from 0.5 to 10 wt.-%, preferably in the range of from 0.5 to 5 wt.-%, more preferably in the range of from 1 to 4 wt.-%, still more preferably in the range of from 2 to 3.5 wt.-% and most preferably in the range of from 2.1 to 3.1 wt.-%, relative to the total weight of the catalyst support body. The metal here is preferably selected from the group consisting of alkali metals, alkaline earth metals, rare earth metals and mixtures thereof.

The specific proportion of metal in the SiO₂-containing catalyst support body brings with it the advantage that these catalyst support bodies have a low surface area without the pore volume decreasing. This has the advantage that catalysts which have a high activity and selectivity with, in addition, high mechanical stability can be provided by using these catalyst support bodies.

### DETAILED DESCRIPTION

By the term “catalyst support body” is meant a support body formed as a shaped body. The catalyst support body can in principle assume the form of any geometric body to which a catalytically active substance can be applied. However, it is preferred if the catalyst support body is formed as a sphere, cylinder (also with rounded end surfaces), perforated cylinder (also with rounded end surfaces), trilobe, “capped tablet”, tetralobe, ring, doughnut, star, cartwheel, “reverse” cartwheel, or as a strand, preferably as a ribbed strand or star strand. The catalyst support body is particularly preferably formed as a sphere or in spherical form or as a ring.

The diameter or the length and thickness of the catalyst support body according to the invention is preferably 2 to 9 mm, depending on the reactor geometry in which the catalyst is to be used. If the catalyst support body is present in spherical form, it preferably has a diameter in the range of from 3 to 8 mm, in particular 4 to 6 mm. If the catalyst support body is present in the form of a ring, it preferably has the following dimensions: (4-6) mm×(4-6) mm×(1-4) mm (diameter×height×hole diameter). Rings with the following dimensions are particularly preferred according to the invention: 5.56 mm×5.56 mm×2.4 mm (diameter×height×hole diameter).

The catalyst support body according to the invention preferably has an average pore radius in the range of from 12 to 30 nm. If the catalyst support body is present in spherical form, it preferably has an average pore radius in the range of from 15 to 30 nm. If the catalyst support body is present in the form of a ring, it preferably has an average pore radius in the range of from 14 to 18 nm. The pore diameters are determined by means of mercury porosimetry in accordance with DIN 66133 at a maximum pressure of 2000 bar.

In addition, the catalyst support body according to the invention preferably has a total pore volume in the range of from 280 to 550 mm³/g. If the catalyst support body is present in spherical form, it preferably has a total pore volume in the range of from 450 to 550 mm³/g, particularly preferably 470 to 530 mm³/g and particularly preferably 480 to 520 mm³/g. If the catalyst support body is present in the form of a ring, it preferably has a total pore volume in the range of from 280 to 500 mm³/g, particularly preferably 300 to 450 mm³/g. The total pore volume is determined by means of mercury porosimetry in accordance with DIN 66133 at a maximum pressure of 2000 bar.

The porosity of the catalyst support body preferably lies in the range of from 40 to 65%, more preferably in the range of from 24 to 60% and most preferably in the range of from 45 to 58%. The porosity is determined by means of mercury porosimetry in accordance with DIN 66133 at a maximum pressure of 2000 bar.

The so-called “bulk density” of the catalyst support body according to the invention preferably lies in the range of from 0.8 to 1.2 g/cm³, particularly preferably in the range of from 0.9 to 1.15 g/cm³ and most preferably in the range of from 1 to 1.1 g/cm³.

By “bulk density” is meant according to the invention the so-called mercury density, which is determined by mercury porosimetry. The Hg porosimetry provides a very reliable, precise and reproducible measurement of the ρ_{Hg}. The ρ_{Hg} is a parameter which is particularly important for the characterization of solids and powders which, once known, provides the apparent volume occupied by the material. ρ_{Hg} is the density of a solid, relative to the external volume of the solid. It is calculated from the sample mass divided by the apparent volume occupied by the sample.

The BET surface area of the catalyst support body according to the invention preferably lies in the range of from 50 to 150 m²/g, particularly preferably in the range of from 50 to 140 m²/g and most preferably in the range of from 60 to 130 m²/g. If the catalyst support body is present in spherical form, it preferably has a BET surface area in the range of from 50 to 120 m²/g, particularly preferably in the range of from 60 to 115 m²/g. If the catalyst support body is present in the form of a ring, it preferably has a BET surface area in the range of from 80 to 135 m²/g, particularly preferably in the range of from 90 to 130 m²/g.

The BET surface area is determined according to the BET method in accordance with DIN 66131; a publication of the BET method is also found in J. Am. Chem. Soc. 60, 309 (1938). In order to determine the surface area of the catalyst support body or of the catalyst according to the invention described later herein, the sample can be measured for example with a fully automatic nitrogen porosimeter from Micromeritics, type ASAP 2010, by means of which an absorption and desorption isotherm is recorded.

The basicity of the catalyst support body can advantageously influence the activity of the catalyst according to the invention produced from it. For example, for the synthesis of vinyl acetate monomer (VAM) it is particularly advantageous if the catalyst support according to the invention has a high basicity. The basicity of the catalyst support body according to the invention or of the catalyst according to the invention described later therefore lies in the range of from 100 to 800 μval/g, particularly preferably in the range of from 110 to 750 μval/g and most preferably in the range of from 130 to 700 μval/g.

By an alkali metal is meant in the present invention a metal from the 1^{st} main group of the periodic table of the elements. Preferably Li, Na or K, more preferably Na or K and most preferably K are used here.

By an alkaline earth metal is meant in the present invention a metal from the 2^{nd} main group of the periodic table of the elements. Preferably Ca, Mg, Sr and Ba, particularly preferably Ca, Sr and Ba are used here.

By a rare earth metal is meant in the present invention a metal from the following list (atomic numbers in brackets): scandium (21), yttrium (39), lanthanum (57), cerium (58), praseodymium (59), neodymium (60), promethium (61), samarium (62), europium (63), gadolinium (64), terbium (65), dysprosium (66), holmium (67), erbium (68), thulium (69), ytterbium (70) and lutetium (71). The following are particularly preferred according to the invention: Y, La, Ce and Nd.

The metal of the catalyst support body according to the invention is particularly preferably an alkali metal, in particular Li, Na or K, wherein Na and K, or K is particularly preferred.

In this case, it is particularly preferred that the total metal content lies in the range of from 0.5 to 5 wt.-%, more preferably in the range of from 1 to 4 wt.-%, still more preferably in the range of from 1.5 to 3.5 wt.-% and most preferably in the range of from 1.6 to 3.1 wt.-%, relative to the total weight of the catalyst support body.

The metal of the catalyst support body is particularly preferably potassium. In this case, it is particularly preferred that the potassium content lies in the range of from 1 to 4 wt.-%, still more preferably in the range of from 1.5 to 3.5 wt.-% and most preferably in the range of from 1.6 to 3.1 wt.-%, relative to the total weight of the catalyst support body.

In the catalyst support body according to the invention, the metal is preferably present bonded in the form of a metal-containing compound, preferably in the form of metal silicates. If alkali metals are used, these are consequently alkali metal silicates. Alkali metal metasilicate and alkali metal orthosilicate are preferred above all here. The metal is particularly preferably potassium and is present in the form of potassium silicates, such as e.g. potassium metasilicate (K₂SiO₃) or potassium orthosilicate (K₄SiO₄). It is not strictly necessary for all the metal to be present in this form, but at least 20%, more preferably at least 30%, still more preferably at least 40%, still more preferably at least 50%, still more preferably at least 60% and most preferably at least 70% of the total potassium of the catalyst support body according to the invention should be present in the form of K₂SiO₃. Alternatively, the potassium can also be present uniformly distributed in the matrix of the SiO₂-containing material in the form of potassium-containing mica or potassium-containing feldspars.

As already mentioned, in addition to the metal-containing compound the catalyst support body also comprises an SiO₂-containing material. The catalyst support body particularly preferably consists of the metal-containing compound and the SiO₂-containing material.

By an “SiO₂-containing material” is meant any synthetic or naturally occurring material which contains silicon dioxide units. The SiO₂-containing material is preferably precipitated or pyrogenic silicic acid, such as for example the synthetically produced silicate Aerosil or a natural sheet silicate.

By the term “natural sheet silicate”, for which the term “phyllosilicate” is also used in the literature, is meant untreated or treated silicate mineral from natural sources in which SiO₄ tetrahedra, which form the structural base unit of all silicates, are cross-linked with each other in layers of the general formula [Si₂O₅]²⁻. These tetrahedron layers alternate with so-called octahedron layers in which a cation, principally Al and Mg (in the form of its cations), is octahedrally surrounded by OH or O. A distinction is drawn for example between two-layer phyllosilicates and three-layer phyllosilicates. Sheet silicates preferred within the framework of the present invention are clay minerals, in particular kaolinite, beidellite, hectorite, saponite, nontronite, mica, vermiculite and smectites, wherein smectites and in particular montmorillonite are particularly preferred. Definitions of the term sheet silicates are also to be found for example in “Lehrbuch der anorganischen Chemie”, Hollemann Wiberg, de Gruyter Verlag, 102^{nd} edition, 2007 (ISBN 978-3-11-017770-1) or in “Römpp Lexikon Chemie”, 10^{th} edition, Georg Thieme Verlag under the heading “Phyllosilikat”. Within the framework of the present invention, a bentonite can also be used as natural sheet silicate. Admittedly, bentonites are not really natural sheet silicates, but rather a mixture of predominantly clay minerals containing sheet silicates. Thus in the present case, where the natural sheet silicate is a bentonite, it is to be understood that the natural sheet silicate is present in the catalyst support body in the form of or as a constituent of a bentonite. Furthermore, the natural sheet silicate can also be a zeolite. If the silicate-containing material is a zeolite, the zeolite can be a fibrous zeolite, foliated zeolite, cubic zeolite, a zeolite with MFI structure, zeolite of the Beta structure type, zeolite A, zeolite X, zeolite Y and mixtures thereof. For example, fibrous zeolites include i.a. natrolite, laumontite, mordenite, thomsonite; foliated zeolites include i.a. heulandite, stilbite; and cubic zeolites include i.a. faujasite, chabazite and gmelinite.

It is furthermore preferred that the catalyst support body contains Zr and/or Nb. In this case, the SiO₂-containing material is preferably doped with Zr and/or Nb, i.e. is present in the catalyst support body in the form of Zr oxide (ZrO₂) or Nb oxide (Nb₂O₅). The Zr oxide or Nb oxide is preferably present in a proportion in the range of from 5 to 25 wt.-%, preferably in a range of from 10 to 20 wt.-% relative to the weight of the catalyst support body without the metal.

If the catalyst support body contains Zr, and if the metal-containing material is a potassium-containing material, then the potassium content preferably lies in the range of from 1.8 to 3.5 wt.-% and most preferably in the range of from 2.1 to 3.1 wt.-%, relative to the total weight of the catalyst support body.

If the catalyst support does not contain Zr, then the potassium content preferably lies in the range of from 1.4 to 2.6 wt.-% and most preferably in the range of from 1.6 to 2.4 wt.-%, relative to the total weight of the catalyst support body.

If the catalyst support body contains Zr and is present in spherical form, it preferably has an average pore radius in the range of from 15 to 20 nm. If the catalyst support body contains Zr and is present in the form of a ring, it preferably has an average pore radius in the range of from 14 to 18 nm.

The present invention also relates to a catalyst that comprises a catalyst support body according to the invention and a catalytically active metal. By a catalytically active metal is meant any metal which can catalyse a catalytic reaction, or oxidation or reduction. The catalytically active metal here is preferably present in a shell of the catalyst support body. Consequently, the catalyst support according to the invention is preferably formed as a shell catalyst.

By the term “shell catalyst” is meant a catalyst which comprises a catalyst support body and a shell with catalytically active material, wherein the shell can be formed in two different ways: Firstly, a catalytically active material can be present in the outer area of the support, with the result that the material of the support serves as matrix for the catalytically active material and the area of the support which is impregnated with the catalytically active material forms a shell around the unimpregnated core of the support. Secondly, a layer in which a catalytically active material is present can be applied to the surface of the catalyst support body. This layer forms the shell of the shell catalyst. In this variant, the catalyst support material is not a constituent of the shell, but the shell is formed by the catalytically active material itself or another matrix material which comprises a catalytically active material. The present invention can involve both named concepts of a shell catalyst, but preferably involves the first-named variant of a shell catalyst, as here the mechanical stability of the catalyst support shaped body material itself is the important influencing variable.

The following metals can be used as catalytically active metals in the catalyst according to the invention: Pd, Pt, Rh, Ir, Ru, Ag, Au, Cu, Ni and Co. Here the metal combinations palladium or platinum combined with gold are particularly preferably used, in particular for the synthesis of VAM.

The catalyst according to the invention preferably has a lateral compressive strength in the range of from 40 to 100 N, more preferably in the range of from 50 to 90 N and most preferably in the range of from 60 to 90 N. By the term “lateral compressive strength” is meant the so-called indentation hardness, breaking strength or also shape stability of a catalyst, or its support body, under compressive load. It is determined by exposing the support body to a pressure between two clamping jaws. The loading pressure that leads precisely to the breaking of the body is determined. This is preferably carried out with an 8M tablet-hardness testing machine (with printer) from Dr. Schleuniger Pharmatron AG. For this, the catalyst is first dried to a constant weight at 130° C. in a halogen dryer. In order to avoid moisture absorption from the air, the samples are kept in a sealed jar with a snap-on lid until measurement. The test is carried out for example with a spherical catalyst by placing the sphere in a cavity between the clamping jaws. In order to determine an average value, the test is carried out with 20 catalysts. The device parameters here are set as follows:
Hardness: N
Distance from the sphere: 5.00 mm
Time delay: 0.80 s
Feed type: 6 D=constant feed speed of 0.7 mm/s until the pressure increases, then constant load increase of 250 N/s until the sphere breaks.

Furthermore, the present invention relates to a method for producing a catalyst support body according to the invention, wherein an SiO₂-containing material is treated with a metal-containing compound, then dried and then calcined at a temperature in the range of from 400 to 1000° C., wherein the metal of the metal-containing compound is selected from the group consisting of alkali metals, alkaline earth metals, rare earth metals and mixtures thereof.

The treatment of the SiO₂-containing material with the metal-containing compound includes both the treatment of the surface of an already shaped catalyst support body and the treatment of the SiO₂-containing material in powder form before being shaped into the catalyst support body.

The metal-containing compound is preferably an organic or inorganic metal salt. Among others, the nitrates, nitrites, carbonates, hydrogen carbonates and silicates of the metals come into consideration in particular here according to the invention. Alternatively, the metal-containing material can also be potassium mica or potassium feldspar, preferably if it is admixed with the SiO₂-containing material in powder form before being shaped into the catalyst support body.

If the metal-containing compound is a potassium-containing compound, it is preferably an organic or inorganic potassium salt. The following come into consideration according to the invention as organic potassium salts: potassium acetate, potassium propionate, potassium oxalate, potassium formate, potassium glycolate and potassium glyoxylate.

The following come into consideration according to the invention as inorganic potassium salts: KNO₃, KNO₂, K₂CO₃, KHCO₃, K₂SiO₃, potassium water glass and KOH, wherein KNO₃, KNO₂ and KHCO₃ are is more preferred and KNO₃ is most preferred.

For the treatment of the SiO₂-containing material as an already preformed catalyst support body, the metal-containing compound is preferably dissolved in a solvent. In addition to the following solvents, acetic acid, acetone and acetonitrile, deionized water is preferred in particular here as solvent. The metal-containing compound, in particular potassium-containing compound, is preferably present in the solvent in a range of from 0.5 to 10 wt.-%, particularly preferably 1 to 8 wt.-%, most preferably 2 to 5 wt.-%.

The treatment of the SiO₂-containing material with a metal-containing compound can take place using numerous procedures known to a person skilled in the art. From a process-engineering point of view, the catalyst support body can advantageously be dipped into the solution according to the invention or the catalyst support body can be sprayed with the solution according to the invention. It is particularly advantageous if the catalyst support body is introduced, in particular dipped, into the solution according to the invention and circulated for example for 2 minutes to 24 hours, in particular 10 to 20 minutes by means of gas, for example air or nitrogen, being passed through it.

A step of treating the SiO₂-containing material with the solution according to the invention using the so-called “pore-filling method” (also called incipient wetness method) is also very advantageous. Embodiment variants of these methods are known to a person skilled in the art and in addition a particularly advantageous embodiment variant is explained in the example section.

The catalyst support body treated with the solution according to the invention, or SiO₂-containing material comprising it, is preferably calcined, after the treatment, in a temperature range of from 400 to 1000° C. A furthermore preferred temperature range for the calcining lies in the range of from 450 to 900° C., more preferably in the range of from 460 to 800° C., still more preferably in the range of from 460 to 750° C., still more preferably in the range of from 465 to 650° C., and most preferably in the range of from 470 to 580° C.

The calcining is preferably carried out in an atmosphere of air, nitrogen or argon.

If the treatment of the SiO₂-containing material with the metal-containing compound is carried out before the shaping into the catalyst support body, the SiO₂-containing material (preferably silicate) is mixed in powder form with preferably pulverulent metal-containing material (preferably potassium mica or potassium feldspar) and then this mixture is subjected to the shaping into the catalyst support body. In this way, the metal-containing material is located uniformly distributed in the catalyst support body. This has the advantage that, during the VAM production in the reactor, the metal (preferably potassium) is slowly released, which is converted to potassium acetate on the surface in the presence of acetic acid.

A further embodiment of the present invention relates to a method for producing a catalyst according to the invention, in which a solution having a precursor compound of a catalytically active metal is applied to a catalyst support body according to the invention. The metals named in connection with the catalyst according to the invention are also the metals which are used in the precursor compound of a catalytically active metal. Examples of Pd-containing precursor compounds are the following: Pd(NH₃)₄(OH)₂, Pd(NH₃)₄(OAc)₂, H₂PdCl₄, Pd(NH₃)₄(HCO₃)₂, Pd(NH₃)₄(HPO₄), Pd(NH₃)₄Cl₂, Pd(NH₃)₄ oxalate, Pd oxalate, Pd(NO₃)₂, Pd(NH₃)₄(NO₃)₂, K₂Pd(OAc)₂(OH)₂, Na₂Pd(OAc)₂(OH)₂, Pd(NH₃)₂(NO₂)₂, K₂Pd(NO₂)₄, Na₂Pd(NO₂)₄, Pd(OAc)₂, K₂PdCl₄, (NH₄)₂PdCl₄, PdCl₂ and Na₂PdCl₄, wherein mixtures of two or more of the above-named salts can also be used. Instead of NH₃ as ligand, ethyleneamine or ethanolamine can also be used here as ligand. In addition to Pd(OAc)₂ other carboxylates of palladium can also be used, preferably the salts of the aliphatic monocarboxylic acids with 3 to 5 carbon atoms, for example the propionate or butyrate salt.

Examples of preferred Au precursor compounds are water-soluble Au salts. According to a particularly preferred embodiment of the method according to the invention, the Au precursor compound is selected from the group consisting of KAuO₂, HAuCl₄, KAu(NO₂)₄, NaAu(NO₂)₄, AuCl₃, NaAuCl₄, KAuCl₄, KAu(OAc)₃(OH), HAu(NO₃)₄, NaAuO₂, NMe₄AuO₂, RbAuO₂, CsAuO₂, NaAu(OAc)₃(OH), RbAu (OAc)₃OH, CsAu(OAc)₃OH, NMe₄Au(OAc)₃OH and Au(OAc)₃. It is recommended where appropriate to produce fresh Au(OAc)₃ or KAuO₂ each time by precipitating the oxide/hydroxide from a gold acid solution, washing and isolating the precipitate as well as taking up same in acetic acid or KOH.

Examples of preferred Pt precursor compounds are water-soluble Pt salts. According to a particularly preferred embodiment of the method according to the invention, the Pt precursor compound is selected from the group consisting of Pt(NH₃)₄(OH)₂, K₂PtCl₄, K₂PtCl₆, Na₂PtCl₆, Pt(NH₃)₄Cl₂, Pt(NH₃)₄(HCO₃)₂, Pt(NH₃)₄(HPO₄), Pt(NO₃)₂, K₂Pt(OAC)₂(OH)₂, Pt(NH₃)₂(NO₂)₂, PtCl₄, H₂Pt(OH)₆, Na₂Pt(OH)₆, K₂Pt(OH)₆, K₂Pt(NO₂)₄, Na₂Pt(NO₂)₄, Pt(OAc)₂, PtCl₂ and Na₂PtCl₄. In addition to Pt(OAc)₂ other carboxylates of platinum can also be used, preferably the salts of the aliphatic monocarboxylic acids with 3 to 5 carbon atoms, for example the propionate or butyrate salt.

Examples of preferred Ag precursor compounds are water-soluble Ag salts. According to a particularly preferred embodiment of the method according to the invention, the Ag precursor compound is selected from the group consisting of Ag(NH₃)₂(OH), Ag(NO₃), Ag citrate, Ag tartrate, ammonium Ag oxalate, K₂Ag(OAc)(OH)₂, Ag(NH₃)₂(NO₂), Ag(NO₂), Ag lactate, Ag trifluoroacetate, Ag oxalate, Ag₂CO₃, K₂Ag(NO₂)₃, Na₂Ag(NO₂)₃, Ag(OAc), ammoniac AgCl solution or ammoniac Ag₂CO₃ solution or ammoniac AgO solution. In addition to Ag(OAc) other carboxylates of silver can also be used, preferably the salts of the aliphatic monocarboxylic acids with 3 to 5 carbon atoms, for example the propionate or butyrate salt. Instead of NH₃ the corresponding ethylenediamines or other diamines of Ag can also be used.

All solvents in which the selected precursor compounds are soluble and which, after deposition onto the catalyst support body, can be easily removed again from same by means of drying are suitable as solvents for the precursor compound. Preferred solvent examples are the following: water, dilute nitric acid, carboxylic acids, in particular acetic acid, propionic acid, glycolic acid and glyoxylic acid, ketones, in particular acetone and MEK (methyl ethyl ketone), MIBK (methyl isobutyl ketone) and nitriles, in particular acetonitrile. As already stated above, a shell catalyst in which the metal precursor compounds are applied to the catalyst in the area of an outer shell of the catalyst support body according to methods known per se is preferably produced by the present method. Thus, the deposition of the solutions of precursor compounds can take place by steeping, by dipping the support into the solution or steeping it according to the incipient wetness method. Alternatively, the solutions can also be sprayed onto the catalyst support body. Particularly preferred here are methods in which a solution of the precursor compound is deposited by spraying the solutions onto a fluidized bed or a fluid bed of the catalyst support body, preferably by means of an aerosol of the solutions. The shell thickness can thereby be continuously adjusted and optimized, for example up to a thickness of 2 mm. But very thin shells with a thickness of less than 100 μm are thus also possible.

In particular, in relation to the production of catalysts for producing VAM, reference is made to DE 10 2007 025 443 A1 with regard to the production method for the catalyst.

After the coating of the catalyst support body according to the invention with the precursor compound(s) of the catalytically active metals, optionally a drying and calcining and/or a reduction of the metal of the precursor compound to the elemental metals can take place.

The reduction of the metal component of the precursor compound to the elemental metal can take place in the liquid phase or gas phase. The following reducing agents can be used in the liquid-phase reduction: hydrazine, formic acid, alkali formates, alkali hypophosphites, citric acid, tartaric acid, malic acid, alcohols, NaBH₄ and oxalic acid.

The gas-phase reduction can take place before incorporation into the reactor for synthesis-related use of the catalyst (ex-situ), but it can also take place in the reactor for the synthesis-related use of the catalyst (in situ). In the so-called ex-situ reduction, reduction is preferably carried out with hydrogen, forming gas or ethylene. The so-called in-situ reduction takes place, in particular in the synthesis of VAM, preferably with ethylene.

The last impregnation step with KOAc needed in conventional synthesis of catalysts for the synthesis of VAM is preferably completely dispensed with in the production of the catalysts according to the invention because the necessary KOAc forms on the potassium-containing catalyst support shaped body in the reactor for producing VAM by contact with the acetic acid used as educt. Simplifications of the process and savings on costs thereby result. In addition, in the so-called in-situ reduction in the reactor the external forming gas reduction is also dispensed with, whereby a further process step in the catalyst production can be left out completely.

It is particularly preferred in the method according to the invention for producing the catalyst according to the invention that the metal of the precursor compound is reduced to elemental metal by gas-phase reduction with ethylene only after the introduction of the catalyst support body containing the precursor compound into the reactor for the synthesis of vinyl acetate monomer.

The present invention therefore also comprises a method for producing VAM in which a catalyst support body according to the invention is produced first, then—as in the production of the catalyst according to the invention—a solution having a precursor compound of a catalytically active metal is applied, after which the catalyst support body with the applied precursor compound is introduced into a reactor for the synthesis of VAM, then the metal component of the precursor compound of the catalytically active metal is reduced to elemental metal by passing ethylene through it, and then acetic acid and ethylene are converted to vinyl acetate monomer by reaction with oxygen in the reactor.

In addition to the above-named embodiments, the present invention also relates to the use of a catalyst support body according to the invention for producing a catalyst. The catalyst can be a catalyst according to the invention, but is not limited thereto.

### BRIEF DESCRIPTION OF THE DRAWINGS

FIG. 1: In FIG. 1 the activity and selectivity of catalysts according to the invention and not according to the invention (5-mm spheres) with respect to the synthesis of VAM are represented.

FIG. 2: In FIG. 2 the activity and selectivity of catalysts according to the invention and not according to the invention (rings) with respect to the synthesis of VAM are represented.

### EXAMPLES

### Example 1

First, six catalyst support bodies (supports 1 to 7) with the following potassium contents (relative to the total weight of the catalyst support) were produced according to the instruction below:

| | Lateral compressive |
|---|---|
| | strength (Newtons): |
| Support 1: 2.2 wt.-% K | 48N |
| Support 2: 1.91 wt.-% K | 41N |
| Support 3: 2.56 wt.-% K | 50N |
| Support 4: 2.77 wt.-% K | 51N |
| Support 5: 3.06 wt.-% K | 47N |
| Support 6: 3.7 wt.-% K | 43N |
| Support 7: no impregnation with | 43N |
| potassium | |

To produce supports 1 to 6, in each case a spherical KA-Zr14 support body (14% ZrO2) from Südchemie AG is impregnated by means of the pore-filling method (incipient wetness) with an aqueous potassium nitrate solution and then left to stand for 1 h. Drying takes place at 120° C. for 16 h. Then calcining is carried out at 550° C. for 5 h in air (heating rate 1° C./min). The concentrations of the KNO₃ impregnating solutions lay in the range of 1-8 wt.-% K and were calculated in each case such that the above-named potassium contents result on the finished support body. Support 7 is a spherical KA-Zr14 support body (14% ZrO2) from Südchemie AG, to which no potassium-containing compound has been applied.

The obtained values of the average pore radius, porosity, total pore volume, bulk density and BET surface area of the obtained supports 1 to 7 are summarized in the following Table 1:

TABLE 1

| | | | | | BET |
|---|---|---|---|---|---|
| | Average | | Total pore | Bulk | surface |
| | pore radius | Porosity | volume | density | area |
| Support | (nm) | (%) | (mm3/g) | (g/cm3) | (m2/g) |
| 1 | 15.1 | 52 | 481 | 1.08 | 112 |
| 2 | 15.7 | 49 | 483 | 1.02 | 118 |
| 3 | 16.9 | 56 | 496 | 1.12 | 100 |
| 4 | 16.8 | 54 | 493 | 1.1 | 93 |
| 5 | 14.9 | 55 | 488 | 1.12 | 94 |
| 6 | 18.5 | 54 | 503 | 1.07 | 87 |
| 7 | 12.9 | 53 | 489 | — | 134 |

### Example 2

### Production of Catalyst A

100 g of support 1 is coated with an aqueous mixed solution of Pd(NH₃)₄(OH)₂ and KAuO₂ (produced by mixing 34.49 g of a 3.415% Pd solution and 10.30 g of a 5.210% Au solution and 100 ml water) in an Innojet IAC025 Coater at 70° C., then dried at 90° C. for 45 min in a fluidized bed dryer (TG200 from Retsch) and reduced at 150° C. for 4 h with forming gas. The LOI-free metal contents of the finished catalyst A determined by chemical elemental analysis are 1.12% Pd and 0.47% Au.

### Example 3

### Production of Catalyst B

Catalyst B was produced in the same way as catalyst A, with the difference that support 2 was used as a starting point and the following initial weights were used:

1. 34.78 g Pd solution
2. 100 ml water
3. 10.36 g Au solution

The LOI-free metal contents of the finished catalyst B determined by chemical elemental analysis are 1.12% Pd and 0.47% Au.

### Example 4

### Production of Catalyst C

Catalyst C was produced in the same way as catalyst A, with the difference that support 3 was used as a starting point and the following initial weights were used:

1. 35.06 g Pd solution
2. 100 ml water
3. 10.46 g Au solution

The LOI-free metal contents of the finished catalyst C determined by chemical elemental analysis are 1.13% Pd and 0.47% Au.

### Example 5

### Production of Catalyst D

Catalyst D was produced in the same way as catalyst A, with the difference that support 4 was used as a starting point and the following initial weights were used:

1. 35.35 g Pd solution
2. 100 ml water
3. 10.55 g Au solution

The LOI-free metal contents of the finished catalyst D determined by chemical elemental analysis are 1.14% Pd+0.48% Au.

### Example 6

### Production of Catalyst E

Catalyst E was produced in the same way as catalyst A, with the difference that support 5 was used as a starting point and the following initial weights were used:

1. 35.65 g Pd solution
2. 100 ml water
3. 10.62 g Au solution

The LOI-free metal contents of the finished catalyst E determined by chemical elemental analysis are 1.17% Pd and 0.49% Au.

### Example 7

### Production of Catalyst F

Catalyst F was produced in the same way as catalyst A, with the difference that support 6 was used as a starting point and the following initial weights were used:

1. 35.94 g Pd solution
2. 100 ml water
3. 10.71 g Au solution

The LOI-free metal contents of the finished catalyst F determined by chemical elemental analysis are 1.18% Pd and 0.49% Au.

### Comparison Example 1

### Catalyst G

In comparison example 1 the untreated KA-Zr14 support from Südchemie AG (support 7) was provided as catalyst G.

### Example 8

### Test Results for Catalysts A to G in Respect of their Selectivity During the Synthesis of Vinyl Acetate Monomer

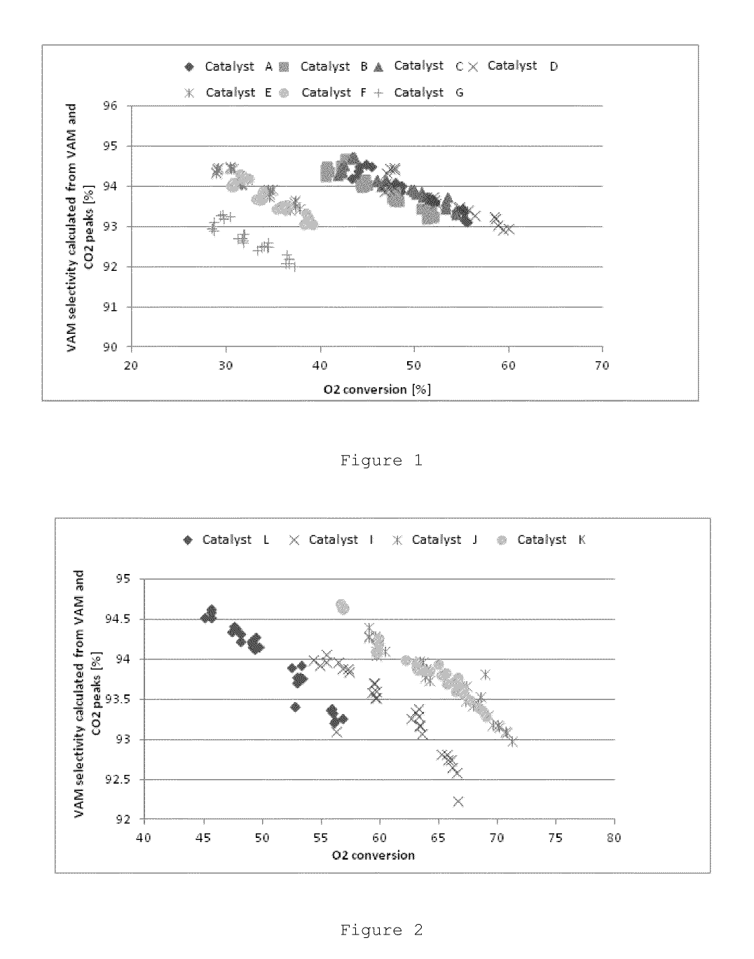

The results for the shell catalysts A to G in respect of the selectivity for the synthesis of vinyl acetate as a function of the oxygen conversion are shown in FIG. 1 and Tables 2 to 4. For this, acetic acid, ethylene and oxygen were each passed over catalysts A to G at a temperature of 140° C./12 h-->143° C./12 h-->146° C./12 h (these are the respective reaction temperatures that apply in turn during the automated execution of the screening protocol, i.e. measurement is carried out for 12 h at 140° C., then for 12 h at 143° C., and then for 12 h at 146° C. reactor temperature) and a pressure of 6.5 bar. The concentrations of the components used were: 39% ethylene, 6% O₂, 0.6% CO₂, 9% methane, 12.5% acetic acid, remainder N₂.

FIG. 1 shows the VAM selectivity of catalysts A to G as a function of the O₂ conversion. The values are also listed in tabular form in Tables 2, 3 and 4:

TABLE 2

| Catalyst A | | Catalyst B | | Catalyst C | |
|---|---|---|---|---|---|
| | VAM | | VAM | | VAM |
| | selectivity | | selectivity | | selectivity |
| | calculated | | calculated | | calculated |
| O2 | from VAM and | O2 | from VAM and | O2 | from VAM and |
| conversion | CO2 peaks | conversion | CO2 peaks | conversion | CO2 peaks |
| [%] | [%] | [%] | [%] | [%] | [%] |
| 44.1958738 | 94.1130853 | 40.6046398 | 94.2547076 | 41.8078247 | 94.2736272 |
| 43.9032475 | 94.1883781 | 40.8586255 | 94.349805 | 42.1819986 | 94.3385959 |
| 43.9208769 | 94.2580189 | 40.6739626 | 94.4084136 | 42.2731826 | 94.3607544 |
| 43.3062056 | 94.2044514 | 40.6210296 | 94.4056453 | 42.1280584 | 94.4606619 |
| 44.058972 | 94.3752548 | 40.709381 | 94.4765333 | 42.5482701 | 94.5183938 |
| 48.5737083 | 93.8682473 | 44.9132786 | 94.0363987 | 46.4649006 | 93.9966287 |
| 48.6575248 | 93.9967539 | 44.6434772 | 94.0092463 | 46.8947694 | 94.162761 |
| 48.504814 | 94.0045022 | 44.3343043 | 94.0157704 | 46.947237 | 94.1432556 |
| 47.998815 | 93.9754144 | 44.3953113 | 93.9777269 | 46.0312986 | 94.1017793 |
| 48.1949006 | 93.9929127 | 44.2630979 | 94.0648884 | 45.9447515 | 94.1758998 |
| 47.9177464 | 94.0897695 | 44.6648678 | 94.1766938 | 50.8121332 | 93.7197861 |
| 52.1553641 | 93.5591583 | 48.2847053 | 93.6351797 | 50.6919781 | 93.8555867 |
| 52.1131701 | 93.6254545 | 48.0017544 | 93.6173901 | 50.2006297 | 93.8235597 |
| 51.9268639 | 93.6808297 | 47.7881016 | 93.6456127 | 49.8910473 | 93.8532078 |
| 51.4129669 | 93.6554402 | 47.6478899 | 93.708993 | 49.867487 | 93.9079706 |
| 51.2579527 | 93.7237264 | 47.9166905 | 93.83847 | 49.6195383 | 93.9205255 |
| 55.5239034 | 93.1003332 | 52.0490025 | 93.2435628 | 54.336478 | 93.3572144 |
| 55.3169216 | 93.147848 | 51.3191372 | 93.1953201 | 54.4078364 | 93.2870406 |
| 55.2764736 | 93.197216 | 51.8494506 | 93.228019 | 53.3158813 | 93.4267101 |
| 55.2429657 | 93.3500606 | 51.7134046 | 93.3876458 | 53.2634591 | 93.5060751 |
| 55.1695258 | 93.443434 | 51.5021667 | 93.3896237 | 53.319901 | 93.6283388 |
| 54.4030676 | 93.3728235 | 50.782723 | 93.4299752 | 53.4437707 | 93.7218596 |
| 45.4640419 | 94.4778699 | 42.6734423 | 94.6815661 | 43.4436313 | 94.6844417 |
| 44.8394249 | 94.5519975 | 42.1277958 | 94.5098028 | 43.5760168 | 94.7451503 |
| 44.1032703 | 94.4884099 | | | 43.3452742 | 94.7400775 |

TABLE 3

| | |
|---|---|
| Catalyst D | Catalyst E |

| | VAM | | VAM |
|---|---|---|---|
| | selectivity | | selectivity |
| | calculated | | calculated |
| O2 | from VAM | O2 | from VAM |
| conversion | and CO2 | conversion | and CO2 |
| [%] | peaks [%] | [%] | peaks [%] |
| 47.7863382 | 93.9824159 | 28.9966776 | 94.4160228 |
| 47.2983296 | 93.9128722 | 28.8596999 | 94.3494732 |
| 46.8332247 | 93.8746998 | 28.8637498 | 94.3244365 |
| 47.5200752 | 94.0479601 | 29.0378649 | 94.4245252 |
| 46.8652528 | 94.0611752 | 29.125576 | 94.4563047 |
| 52.2839538 | 93.5736142 | 31.6187192 | 94.0656836 |
| 52.1514345 | 93.6448303 | 32.2336695 | 94.1713134 |
| 52.0073902 | 93.7420259 | 31.6069035 | 94.0441237 |
| 51.3142963 | 93.6266654 | 31.5563351 | 94.0488819 |
| 51.285434 | 93.7274798 | 31.490508 | 94.0516561 |
| 56.4194497 | 93.2687689 | 34.5826179 | 93.732373 |
| 55.6865437 | 93.4031597 | 34.5168842 | 93.8028064 |
| 55.1305146 | 93.3904845 | 34.9490458 | 93.9172952 |
| 54.6982866 | 93.4571249 | 34.2941781 | 93.7979584 |
| 54.7874787 | 93.4841245 | 34.6463169 | 93.8903272 |
| 59.9408749 | 92.944086 | 34.390048 | 93.9192732 |
| 59.3681049 | 92.9110195 | 37.7607087 | 93.442119 |
| 58.8248884 | 93.0409964 | 37.344797 | 93.4918367 |
| 58.6206577 | 93.191634 | 36.7597952 | 93.4078574 |
| 58.4166718 | 93.2429166 | 37.2664939 | 93.585261 |
| 47.7970127 | 94.4571502 | 37.2980384 | 93.6606468 |
| 47.8660269 | 94.4165939 | 30.787359 | 94.4380473 |
| 46.9735937 | 94.3333121 | 30.4373628 | 94.4735871 |
| 47.3320327 | 94.4224681 | 30.4916596 | 94.4332844 |
| | | 30.3636171 | 94.4984305 |

TABLE 4

| | |
|---|---|
| Catalyst F | Catalyst G |

| | VAM | | VAM |
|---|---|---|---|
| | selectivity | | selectivity |
| | calculated | | calculated |
| O2 | from VAM | O2 | from VAM |
| conversion | and CO2 | conversion | and CO2 |
| [%] | peaks [%] | [%] | peaks [%] |
| 30.5748849 | 94.0125264 | 30.5748849 | 93.0125264 |
| 30.7055317 | 93.9952479 | 30.7055317 | 92.9952479 |
| 30.7229182 | 94.0745558 | 30.7229182 | 93.0745558 |
| 30.4823753 | 94.0124357 | 30.4823753 | 93.0124357 |
| 33.6296184 | 93.6568761 | 33.6296184 | 92.6568761 |
| 33.8253004 | 93.6956283 | 33.8253004 | 92.6956283 |
| 33.7754725 | 93.6816885 | 33.7754725 | 92.6816885 |
| 33.1574551 | 93.6669768 | 33.1574551 | 92.6669768 |
| 33.8467116 | 93.8306242 | 33.8467116 | 92.8306242 |
| 33.8161855 | 93.8640232 | 33.8161855 | 92.8640232 |
| 36.3052539 | 93.4127322 | 36.3052539 | 92.4127322 |
| 36.4644735 | 93.5021524 | 36.4644735 | 92.5021523 |
| 36.4553263 | 93.5508457 | 36.4553263 | 92.5508457 |
| 35.9695331 | 93.5214337 | 35.9695331 | 92.5214337 |
| 35.7599772 | 93.487082 | 35.7599772 | 92.487082 |
| 35.3295978 | 93.4457788 | 35.3295978 | 92.4457788 |
| 39.2069861 | 93.061523 | 39.2069861 | 92.061523 |
| 38.6039337 | 93.0762274 | 38.6039337 | 92.0762274 |
| 38.2782149 | 93.0579698 | 38.2782149 | 92.0579698 |
| 38.68169 | 93.2243742 | 38.68169 | 92.2243741 |
| 38.4583954 | 93.3143349 | 38.4583954 | 92.3143349 |
| 32.3562577 | 94.2033864 | 32.3562577 | 93.2033863 |
| 31.7337826 | 94.1640549 | 31.7337826 | 93.1640549 |
| 31.4133982 | 94.2935193 | 31.4133982 | 93.2935193 |
| 31.6287934 | 94.2834548 | 31.6287934 | 93.2834548 |

### Example 9

First, four catalyst support bodies (supports 8 to 11) with the following potassium contents (relative to the total weight of the catalyst support) were produced according to the instruction below:

### Support 8: 1.88 wt.-% K

### Support 9: 2.3 wt.-% K

### Support 10: 2.9 wt.-% K

Support 11: no impregnation with potassium nitrate

To produce supports 8 to 10, in each case an annular KA-Zr14 support body (14% ZrO2) from Südchemie AG is impregnated by means of the pore-filling method (incipient wetness) with an aqueous potassium nitrate solution and then left to stand for 1 h. Drying takes place at 120° C. for 16 h. Then calcining is carried out at 550° C. for 5 h in air (heating rate 1° C./min). The concentrations of the KNO₃ impregnating solutions lay in the range of 1-8 wt.-% K and were calculated in each case such that the above-named potassium contents result on the finished support body. Support 11 is an annular KA-Zr14 support body (14% ZrO2) from Südchemie AG, to which no potassium-containing compound has been applied.

The obtained values of the average pore radius, porosity, total pore volume, bulk density and BET surface area of the obtained supports 8 to 11 are summarized in the following Table 5:

TABLE 5

| | | | | | BET |
|---|---|---|---|---|---|
| | Average | | Total pore | Bulk | surface |
| | pore radius | Porosity | volume | density | area |
| Support | (nm) | (%) | (mm3/g) | (g/cm3) | (m2/g) |
| 8 | 16.3 | 41 | 357 | — | 109 |
| 9 | 17.4 | 47 | 390 | — | 106 |
| 10 | 15.7 | 45 | 382 | — | 102 |
| 11 | 16.7 | 43 | 372 | 1.16 | 126 |

### Example 10

### Production of Catalyst I

Catalyst I was produced by coating 100 g of support 8 with a mixed solution of 27.44 g of a 4.76% Pd(NH₃)₄(OH)₂ solution and 12.09 g of a 3.60% KAuO₂ solution and 100 ml water at 70° C. in an Innojet Aircoater IAC025, drying it in a fluidized bed dryer at 90° C./40 min and reducing it with forming gas at 150° C./4 h, and finally impregnating it for 1 h with aqueous KOAc solution at to room temperature according to the pore-filling method (incipient wetness). The LOI-free metal load determined by chemical analysis was 1.2% Pd+0.4% Au.

### Example 11

### Production of Catalyst J

Catalyst J was produced just like catalyst I, with the difference that support 9 was used as support and the following contents were used:

18.26 g Pd solution
10.87 g Au solution
100 ml water
80 g support

The LOI-free metal load determined by chemical analysis was 1% Pd+0.47% Au.

### Example 12

### Production of Catalyst K

Catalyst K was produced just like catalyst I, with the difference that support 10 was used as support and the following contents were used:

18.26 g Pd solution
10.87 g gold solution
100 ml water

The LOI-free metal load determined by chemical analysis was 1% Pd+0.45% Au.

### Comparison Example 2

### Production of Catalyst L

Catalyst L was produced just like catalyst I, with the difference that support 11 was used as support and the following contents were used:

18.26 g Pd solution
10.87 g gold solution
100 ml water.

The LOI-free metal load determined by chemical analysis was 1.02%

Pd+0.48% Au.

### Example 13

### Test Results for Catalysts I to L in Respect of their Selectivity During the Synthesis of Vinyl Acetate Monomer

The same tests as in Example 8 were carried out, but with catalysts I to L. FIG. 2 shows the VAM selectivity of catalysts I to L as a function of the O₂ conversion. The values are also listed in tabular form in Tables 6 and 7.

TABLE 6

| | |
|---|---|
| Catalyst L | Catalyst I |

| | VAM | | VAM |
|---|---|---|---|
| | selectivity | | selectivity |
| | calculated | | calculated |
| O2 | from VAM | O2 | from VAM |
| conversion | and CO2 | conversion | and CO2 |
| [%] | peaks [%] | [%] | peaks [%] |
| 45.0954313 | 94.5168225 | 54.2934023 | 93.9900195 |
| 45.6800697 | 94.6168477 | 54.8823205 | 93.9156301 |
| 45.6631349 | 94.5202031 | 55.3940715 | 93.9593098 |
| 45.6570054 | 94.5805315 | 55.4018729 | 94.0558982 |
| 49.4621084 | 94.2680568 | 56.2627037 | 93.0973861 |
| 49.3147698 | 94.1206872 | 59.6303077 | 93.5089996 |
| 49.1652488 | 94.1837412 | 59.3415051 | 93.5820371 |
| 49.6712029 | 94.1477952 | 59.6693995 | 93.5130357 |
| 49.134 | 94.155825 | 59.6597815 | 93.6003053 |
| 49.0985827 | 94.2182181 | 59.4698682 | 93.6872267 |
| 49.1659852 | 94.1882126 | 59.4613171 | 93.7045212 |
| 53.4292061 | 93.7553089 | 63.3807874 | 93.1822012 |
| 53.2140064 | 93.7683643 | 63.589953 | 93.0637687 |
| 53.3136011 | 93.9185048 | 63.2589117 | 93.2823406 |
| 52.7880386 | 93.4032093 | 63.3241766 | 93.3760389 |
| 52.4798825 | 93.8955565 | 63.0213054 | 93.3334624 |
| 52.9201899 | 93.7691241 | 63.3502495 | 93.1631366 |
| 52.931216 | 93.7078964 | 62.6845059 | 93.2601444 |
| 56.7913325 | 93.2630452 | 66.5139379 | 92.5878475 |
| 56.1461489 | 93.2266369 | 66.1864229 | 92.6468693 |
| 56.1247163 | 93.2056957 | 66.6536031 | 92.2347492 |
| 56.0188807 | 93.3291673 | 66.0389442 | 92.7465856 |
| 55.8789647 | 93.3747564 | 65.7155104 | 92.8122888 |
| 55.7879583 | 93.3710147 | 65.804345 | 92.7377517 |
| 48.1474093 | 94.3054663 | 65.2712406 | 92.8072887 |
| 48.1350726 | 94.2155292 | 57.3312404 | 93.8451406 |
| 47.7504107 | 94.3796496 | 57.2760603 | 93.8808583 |
| 47.5574801 | 94.4076387 | 56.8238323 | 93.8750426 |
| 47.3786553 | 94.3430426 | 56.4661535 | 93.9535552 |

TABLE 7

| | |
|---|---|
| Catalyst J | Catalyst K |

| | VAM | | VAM |
|---|---|---|---|
| | selectivity | | selectivity |
| | calculated | | calculated |
| O2 | from VAM | O2 | from VAM |
| conversion | and CO2 | conversion | and CO2 |
| [%] | peaks [%] | [%] | peaks [%] |
| 59.7166638 | 94.0921631 | 59.7281147 | 94.0838224 |
| 59.6970849 | 94.1619346 | 59.7775655 | 94.08703 |
| 59.7125821 | 94.0444729 | 59.9039753 | 94.2577755 |
| 59.6926818 | 94.1501189 | 59.8601517 | 94.1959539 |
| 60.4092034 | 94.1012585 | 64.2367417 | 93.8546347 |
| 64.1987848 | 93.730831 | 63.7644231 | 93.8542761 |
| 63.971323 | 93.8763166 | 63.2207694 | 93.8699994 |
| 63.9262515 | 93.8427527 | 63.078985 | 93.944114 |
| 63.8586069 | 93.7723549 | 63.0597405 | 93.9170728 |
| 63.6474809 | 93.9552313 | 62.1479903 | 93.9934372 |
| 63.3825443 | 93.9739322 | 63.0984235 | 93.8991691 |
| 68.3307204 | 93.4288628 | 66.7346753 | 93.6528078 |
| 67.9138551 | 93.4136275 | 66.2920278 | 93.7102456 |
| 68.5550135 | 93.5335014 | 66.6028913 | 93.7654609 |
| 67.3649749 | 93.6588003 | 65.6231982 | 93.8262554 |
| 66.8421089 | 93.6678295 | 64.961215 | 93.9396765 |
| 67.2348077 | 93.4727015 | 65.2610206 | 93.7964741 |
| 68.9313176 | 93.8160609 | 65.6879887 | 93.6912202 |
| 71.2001651 | 92.9719172 | 69.010619 | 93.2776025 |
| 70.6851252 | 93.0913972 | 68.3405318 | 93.3879266 |
| 70.7952691 | 93.0862081 | 68.6980474 | 93.3470348 |
| 70.1249943 | 93.1451319 | 67.6717257 | 93.4861717 |
| 69.5898969 | 93.1810788 | 67.0738179 | 93.6329867 |
| 70.0054543 | 93.1814042 | 67.1543297 | 93.5487534 |
| 69.2122042 | 93.3018437 | 66.4658098 | 93.5982513 |
| 59.6082029 | 94.278968 | 56.8066598 | 94.6196663 |
| 59.0162963 | 94.2728859 | 56.887838 | 94.6407874 |
| 59.0724251 | 94.3996695 | 56.6081832 | 94.6845792 |
| 59.0399203 | 94.2786839 | 12.9614636 | 91.914302 |

### Example 14

First, six catalyst support bodies (supports 12 to 18) with the following potassium contents (relative to the total weight of the catalyst support) were produced according to the instruction below:

### Support 12: 2.54 wt.-% K

### Support 13: 2.75 wt.-% K

### Support 14: 3.06 wt.-% K

### Support 15: 2.24 wt.-% K

### Support 16: 1.93 wt.-% K

### Support 17: 1.64 wt.-% K

Support 18: no impregnation with potassium

To produce supports 12 to 17, in each case a spherical KA-160 support body (without ZrO2 doping) from Südchemie AG is impregnated by means of the pore-filling method (incipient wetness) with an aqueous potassium nitrate solution and then left to stand for 1 h. Drying takes place at 120° C. for 16 h. Then calcining is carried out at 550° C. for 5 h in air (heating rate 1° C./min). The concentrations of the KNO₃ impregnating solutions lay in the range of 1-8 wt.-% K and were calculated in each case such that the above-named potassium contents result on the finished support body. Support 18 was an unimpregnated KA-160 support body.

The obtained values of the average pore radius, porosity, total pore volume, bulk density and BET surface area of the obtained supports 12 to 18 are summarized in the following Table 8:

TABLE 8

| | | | | | BET |
|---|---|---|---|---|---|
| | Average | | Total pore | Bulk | surface |
| | pore radius | Porosity | volume | density | area |
| Support | (nm) | (%) | (mm3/g) | (g/cm3) | (m2/g) |
| 12 | 29.8 | 53.5 | 546 | 0.98 | 72 |
| 13 | 34.2 | 52.7 | 542 | 0.97 | 54 |
| 14 | 34.7 | 58.7 | 562 | 1.04 | 53 |
| 15 | 30 | 52.7 | 546 | 0.96 | 82 |
| 16 | 22.3 | 53.1 | 533 | 0.99 | 102 |
| 17 | 19 | 50.1 | 537 | 0.93 | 117 |
| 18 | 12 | 50.27 | 547 | 0.92 | 150 |

1. A catalyst support body containing an SiO₂-containing material and a metal selected from the group consisting of alkali metals, alkaline earth metals, rare earth metals and mixtures thereof, wherein the total metal content lies in the range of from 0.5 to 10 wt.-%, relative to the total weight of the catalyst support body, and wherein the BET surface area of the catalyst support body lies in the range of from 50 to 150 m²/g.

2. The catalyst support body according to claim 1, wherein the catalyst support body is present in the form of spheres or rings.

3. The catalyst support body according to claim 1, having an average pore radius in the range of from 12 to 30 nm.

4. The catalyst support body according to claim 1, having a total pore volume in the range of from 280 to 550 mm³/g.

5. The catalyst support body according to claim 1, having a bulk density in the range of from 0.8 to 1.2 g/cm³.

6. The catalyst support body according to claim 1, having BET surface area in the range of from 50 to 140 m²/g.

7. The catalyst support body according to claim 1, having a basicity in the range of from 100 to 800 μval/g.

8. The catalyst support body according to claim 1, wherein the metal is Li, Na or K.

9. The catalyst support body according to claim 8, wherein the total Li, Na or K content lies in the range of from 0.5 to 10 wt.-%, relative to the total weight of the catalyst support body.

10. The catalyst support body according to claim 8, wherein the metal is K, and the total K content lies in the range of from 2.1 to 3.1 wt.-%, relative to the total weight of the catalyst support body.

11. The catalyst support body according to claim 1, wherein the catalyst support body additionally contains Zr and/or Nb.

12. The catalyst support body according to claim 11, wherein the metal is K, and the total K content lies in the range of from 1.6 to 2.4 wt.-%, relative to the total weight of the catalyst support body.

13. The catalyst support body according to claim 8, wherein potassium is present in bonded form as potassium silicate.

14. The catalyst support body according to claim 1, wherein the SiO₂-containing material is precipitated or pyrogenic silicic acid.

15. The catalyst support body according to claim 1, wherein the SiO₂-containing material is a silicate.

16. A catalyst comprising a catalyst support body according to claim 1 and a catalytically active metal.

17. The catalyst according to claim 16, having a lateral compressive strength in the range of from 40 to 100 N.

18. The catalyst according to claim 16, wherein the catalytically active metal is Pd and/or Au.

19. A method for producing a catalyst support body according to claim 1, wherein an SiO₂-containing material is treated with a metal-containing compound, then dried and then calcined at a temperature in the range of from 400 to 1000° C., and wherein the metal of the metal-containing compound is selected from the group consisting of alkali metals, alkaline earth metals, rare earth metals and mixtures thereof.

20. The method according to claim 19, wherein calcining is carried out for 1 to 12 h.

21. The method according to claim 19, wherein the metal-containing compound is an organic or inorganic metal salt.

22. The method according to claim 21, wherein the metal salt is selected from the group consisting of KNO₃, KNO₂, K₂CO₃, KHCO₃ and KOH.

23. The method according to claim 19, wherein the treatment of the SiO₂-containing material with the metal-containing compound takes place by mixing two powders of these components.

24. A method for producing a catalyst comprising a catalyst support body and a catalytically active metal, wherein a solution having a precursor compound of the catalytically active metal is applied to the catalyst support body according to claim 1.

25. The method according to claim 24, wherein the metal of the precursor compound is reduced to elemental metal by gas-phase reduction with ethylene only after the introduction of the catalyst support body containing the precursor compound into the reactor for the synthesis of vinyl acetate monomer.

26. (canceled)
